(19) United States
(12) Patent Application Publication
(10) Pub. No.: US 2011/0259281 A1
(43) Pub. Date: Oct. 27, 2011

(54) DE-SHEDDING TOOL AND METHOD OF MANUFACTURING THE SAME

(76) Inventor: Chi Kin John MAK, Hong Kong (HK)

(21) Appl. No.: 13/010,767

(22) Filed: Jan. 20, 2011

Related U.S. Application Data
(60) Provisional application No. 61/326,665, filed on Apr. 22, 2010.

(51) Int. Cl. A01K 13/00; B23P 11/00

(52) U.S. Cl. 119/631; 29/428

(57) ABSTRACT

A de-shedding tool includes first and second thin plates, and first and second rows of spaced apart teeth formed along first and second longitudinal edges of the first and second plates respectively. The first and second plates are superimposed and longitudinally offset such that the offset first and second rows of equally spaced apart teeth together form a plurality of continuous serrated teeth. The teeth have surfaces with a roughness sufficient to engage and pull away loose hair when the teeth slide through the hair of an animal. A method of manufacturing the de-shedding tool is also disclosed.

### CROSS-REFERENCE TO RELATED APPLICATIONS

This application claims benefit of U.S. Provisional Patent Application No. 61/326,665 filed on Apr. 22, 2010, the entire content of which is hereby incorporated by reference.

### FIELD OF PATENT APPLICATION

The present patent application relates to a de-shedding tool for animals such as dogs and cats. The present patent application also relates to a method of manufacturing a de-shedding tool.

### BACKGROUND

In the market, there are plenty of handheld de-shedding tools for animals such as dogs, cats, horses and cattle, etc. However, these existing tools are heavy in weight because thick pieces of metal plate are used. Furthermore, along the blade edge of the metal plate, teeth are formed by grinding. Hence, the manufacturing process of these conventional de-shedding tools is time-consuming and costly.

There is a need to produce a handheld de-shedding tool for animals that is light in weight, easy and fast to manufacture, and low in manufacturing cost.

The above description of the background is provided to aid in understanding a de-shedding tool, but is not admitted to describe or constitute pertinent prior art to the de-shedding tool disclosed in the present application, or consider any cited documents as material to the patentability of the claims of the present application.

### SUMMARY

According to one aspect, there is provided a de-shedding tool including:
first and second plates; and
first and second rows of spaced apart teeth formed along first and second longitudinal edges of the first and second plates respectively;
wherein the first and second plates are superimposed on each other and longitudinally offset such that the offset first and second rows of spaced apart teeth together form a plurality of continuous serrated teeth; and
wherein the teeth have surfaces with a roughness sufficient to engage and pull away loose hair when the teeth slide through the hair of an animal.

In one embodiment, the teeth on each row of spaced apart teeth are equally spaced apart.

In one embodiment, the teeth on each row of equally spaced apart teeth have a pitch distance larger than the width of each tooth.

In one embodiment, the teeth on each row of equally spaced apart teeth have a pitch distance double the width of each tooth, and the formed continuous serrated teeth have a pitch distance equal to the width of each tooth.

In one embodiment, the first and second plates are formed with alignment holes for aligning the first and second plates in a predetermined offset position.

In one embodiment, the teeth have substantially the same width, height and shape.

In one embodiment, the teeth are generally triangular in shape.

The de-shedding tool further includes a plurality of screws for inserting through the alignment holes, and a plurality of nuts threadably coupled to the plurality of screws respectively for tightly fastening the first and second plates together.

The de-shedding tool further includes a housing for holding the first and second plates therein with the teeth exposed outwardly therefrom.

The de-shedding tool further includes a handle integrally formed with the housing.

In one embodiment, the first and second plates are oriented transversely and at an angle with respect to the handle.

In one embodiment, the housing is generally arcuate in shape, and the handle is formed on an upper surface of the housing.

In one embodiment, the handle is generally in the form of a hand knob.

In one embodiment, the first and second plates are made of metal.

In one embodiment, the thickness of the first and second metal plates is less than 1.0 mm.

The de-shedding tool further includes at least one more plate having at least one more row of spaced apart teeth formed along a longitudinal edge thereof; the first, second and at least one more plates being superimposed on each other and offset longitudinally such that the offset first, second and at least one more rows of teeth together form a plurality of continuous serrated teeth.

In one embodiment, the teeth on each row of teeth are spaced equally apart at a distance at least double the width of each tooth.

According to another aspect, there is provided a method of manufacturing a de-shedding tool comprising the steps of:
producing a first plate having, along a longitudinal edge thereof, a first row of spaced apart teeth having surfaces with a roughness sufficient to engage and pull away loose hair when the teeth slide through the hair of an animal;
producing a second plate having, along a longitudinal edge thereof, a second row of spaced apart teeth having surfaces with a roughness sufficient to engage and pull away loose hair when the teeth slide through the hair of an animal; and
   arranging the first and second plates in a superimposed and longitudinally offset position such that the offset first and second rows of spaced apart teeth together form a plurality of continuous serrated teeth.

The method further includes the steps of forming first and second sets of longitudinally offset alignment holes in the first and second plate respectively.

The method further includes the step of fastening the first and second plates in a housing with the teeth exposed outwardly therefrom.

The method further includes the step of forming a handle with the housing.

In one embodiment, the plate-producing steps include producing the first and second plates from metal by stamping through a raw metal plate by a metal stamping machine.

In one embodiment, the plate-producing steps include producing the first and second plates from plastic by a cutting machine or a molding machine.

Although the de-shedding tool disclosed in the present application is shown and described with respect to certain embodiments, it is obvious that equivalents and modifications will occur to others skilled in the art upon the reading and understanding of the specification. The present application includes all such equivalents and modifications, and is limited only by the scope of the claims.

### BRIEF DESCRIPTION OF THE DRAWINGS

Specific embodiments of the de-shedding tool disclosed in the present application will now be described by way of example with reference to the accompanying drawings.

FIG. 1 is a perspective view of the de-shedding tool according to a first embodiment disclosed in the present application.

FIG. 2 is an exploded view of the de-shedding tool of FIG. 1 showing the first and second plates.

FIG. 2a is an enlarged fragmentary view of the teeth of the first plate shown in the upper circle in FIG. 2.

FIG. 2b is an enlarged fragmentary view of the teeth of the second plate shown in the lower circle in FIG. 2.

FIG. 3 is an explode view of the de-shedding tool of FIG. 1 showing the first and second plates in a superimposed position.

FIG. 3a is an enlarged fragmentary view of the teeth of the superimposed first and second plates shown in the circle of FIG. 3.

FIG. 4a shows a top plan view of the two plates and their offset relationship according to an embodiment disclosed in the present application.

FIG. 4b shows a top plan view of the two plates being disposed in a superimposed and offset position.

FIG. 4c shows a side view of the two superimposed plates of FIG. 4b.

FIG. 5 illustrates a thin metal plate with a row of teeth formed by stamping through a thin raw metal plate.

FIG. 6 is an enlarged view of the teeth of the plate illustrating the rough surface formed along the edges of the teeth.

FIG. 7 shows a perspective view of a de-shedding tool according to a second embodiment disclosed in the present application.

FIG. 8 is an exploded view of the de-shedding tool of FIG. 7 showing the first and second plates.

FIG. 8a is an enlarged fragmentary view of the teeth of the first plate shown in the circle on the left hand side of FIG. 8.

FIG. 8b is an enlarged fragmentary view of the teeth of the second plate shown in the circle on the right hand side of FIG. 8.

FIG. 9 is an exploded view of the de-shedding tool of FIG. 7 showing the first and second plates in a superimposed and off set position.

FIG. 9a is an enlarged fragmentary view of the teeth of the superimposed and offset first and second plates shown in the circle of FIG. 9.

FIG. 10 shows a perspective view of a de-shedding tool according to a third embodiment disclosed in the present application.

### DETAILED DESCRIPTION

Reference will now be made in detail to a preferred embodiment of the de-shedding tool disclosed in the present application, examples of which are also provided in the following description. Exemplary embodiments of the de-shedding tool disclosed in the present application are described in detail, although it will be apparent to those skilled in the relevant art that some features that are not particularly important to an understanding of the de-shedding tool may not be shown for the sake of clarity.

Furthermore, it should be understood that the de-shedding tool disclosed in the present application is not limited to the precise embodiments described below and that various changes and modifications thereof may be effected by one skilled in the art without departing from the spirit or scope of the appended claims. For example, elements and/or features of different illustrative embodiments may be combined with each other and/or substituted for each other within the scope of this disclosure and appended claims.

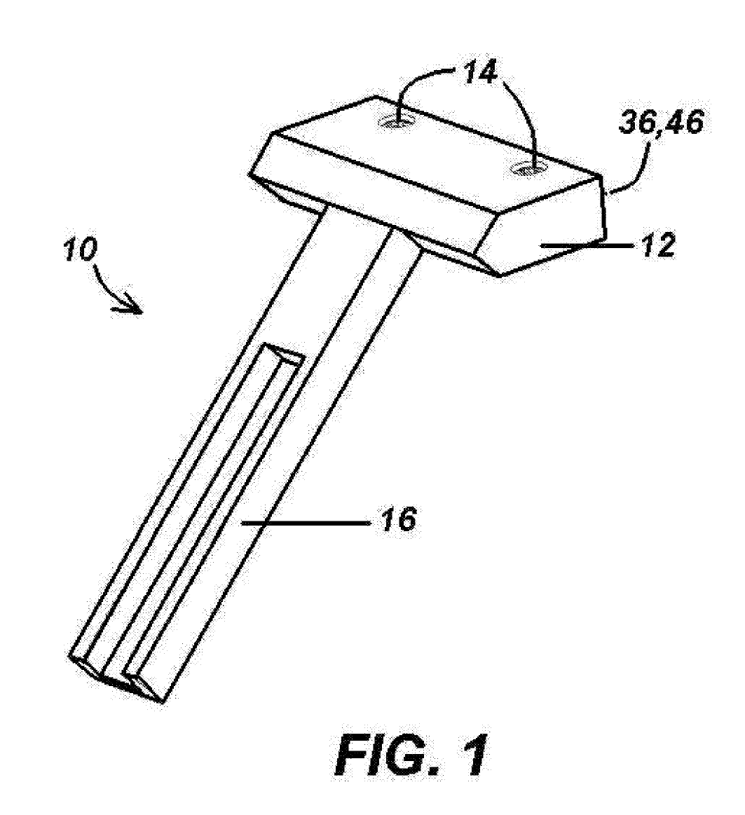

FIGS. 1-3 are perspective and exploded views of a handheld de-shedding tool 10 according to a first embodiment disclosed in the present application.

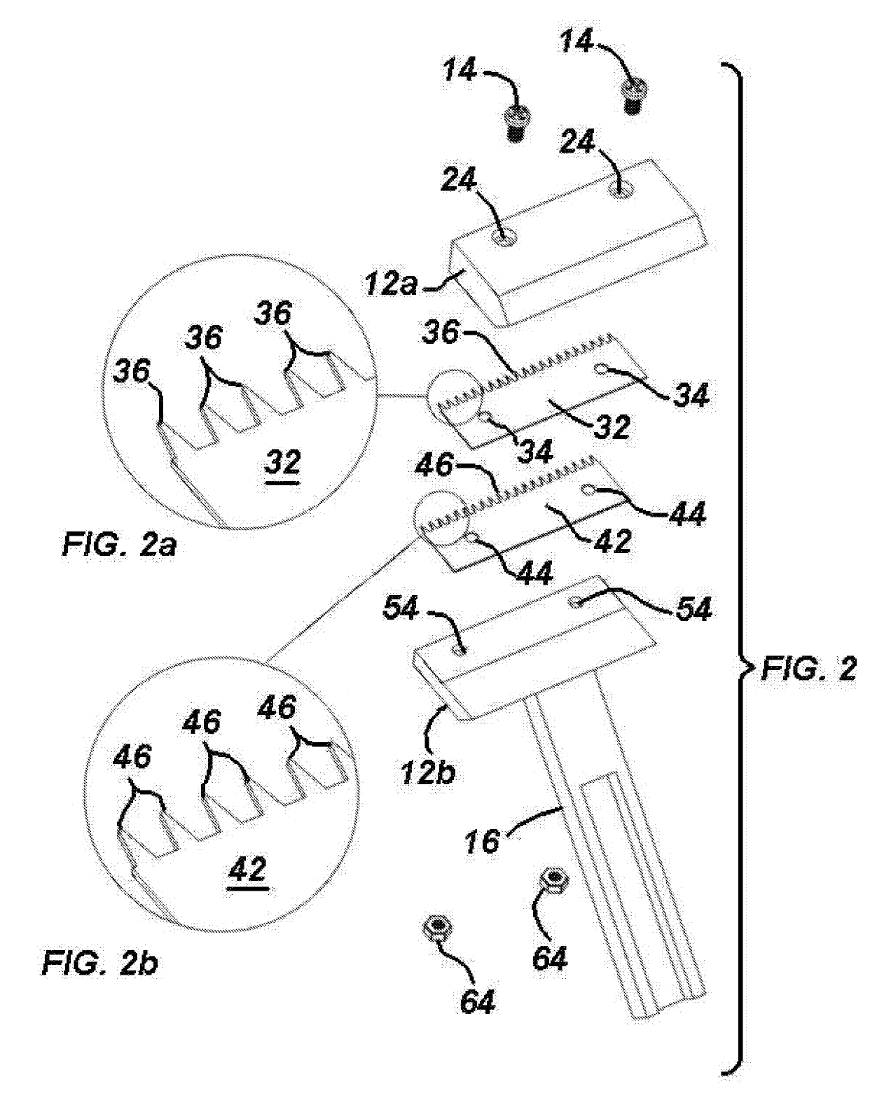

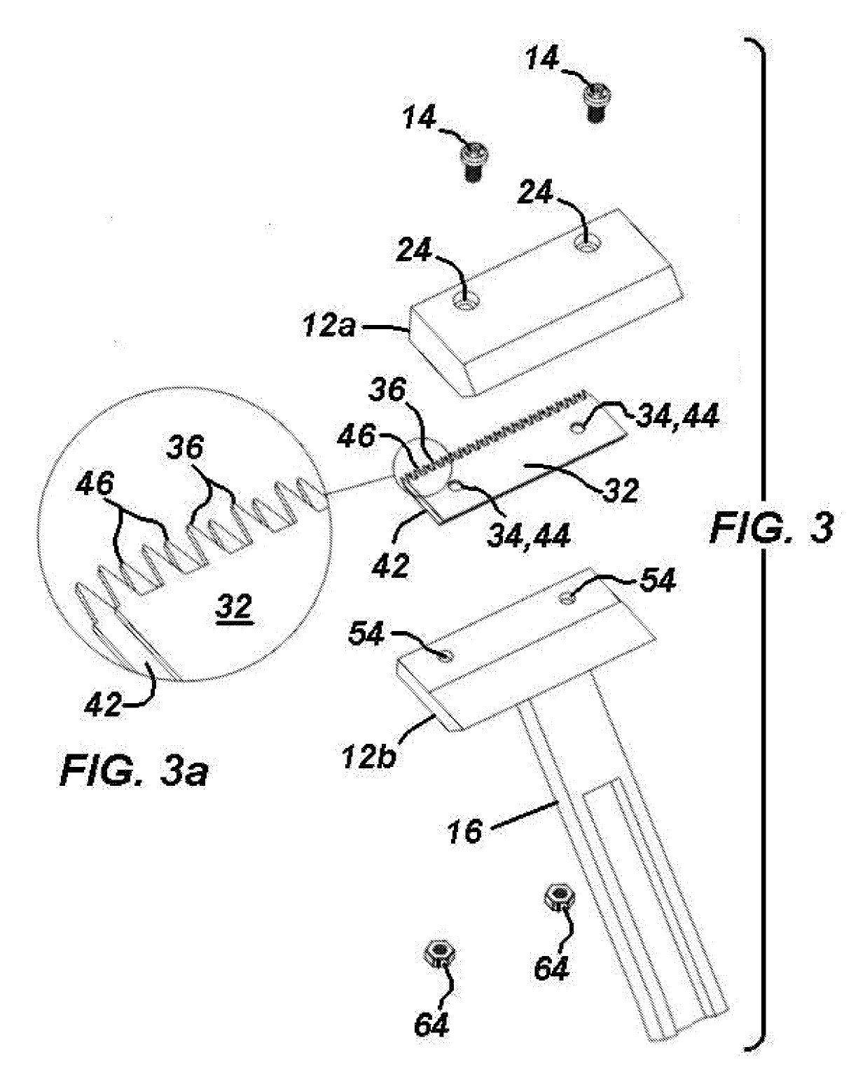

As shown in FIGS. 2, 2a and 2b, the de-shedding tool 10 may include two thin plates 32, 42. Two rows of equally spaced apart teeth 36, 46 may be formed along the longitudinal edges of the two plates 32, 42 respectively. As shown in FIGS. 3 and 3a, the two plates 32, 42 may be superimposed on each other and longitudinally offset such that the two offset rows of teeth 36, 46 together form a plurality of continuous serrated teeth 36, 46.

The two plates 32, 42 may be formed with alignment holes 34, 44 respectively for aligning the two plates 32, 42 in a predetermined offset position. Details of the alignment of the two plates 32, 42 will be described later.

The de-shedding tool 10 may include a housing 12 for holding the two plates 32, 42 therein with the teeth 36, 46 exposed outwardly therefrom. The housing 12 may be formed of an upper housing portion 12a and a lower housing portion 12b. A plurality of screws 14 may be inserted through alignment holes 34, 44 of the plates 32, 42 and fastening holes 24, 54 of the upper and lower housing portions 12a, 12b. A plurality of nuts 64 may be threadably coupled to the plurality of screws 14 for tightly fastening the first and second plates 32, 42 and the upper and lower housing portions 12a, 12b together.

The de-shedding tool 10 may further include a handle 16. The handle 16 may be integrally formed with the lower housing portion 12b. The upper and lower housing portions 12a, 12b and the handle 16 may be made of plastic. It can be seen that the two superimposed plates 32, 42 can be oriented transversely and at an angle with respect to the handle 16 to facilitate easy gripping and manipulating of the de-shedding tool 10 by a user.

The handheld de-shedding tool 10 of the present embodiment carries two simple and thin plates 32, 42. These two thin plates 32, 42 can reduce the weight of the de-shedding tool 10.

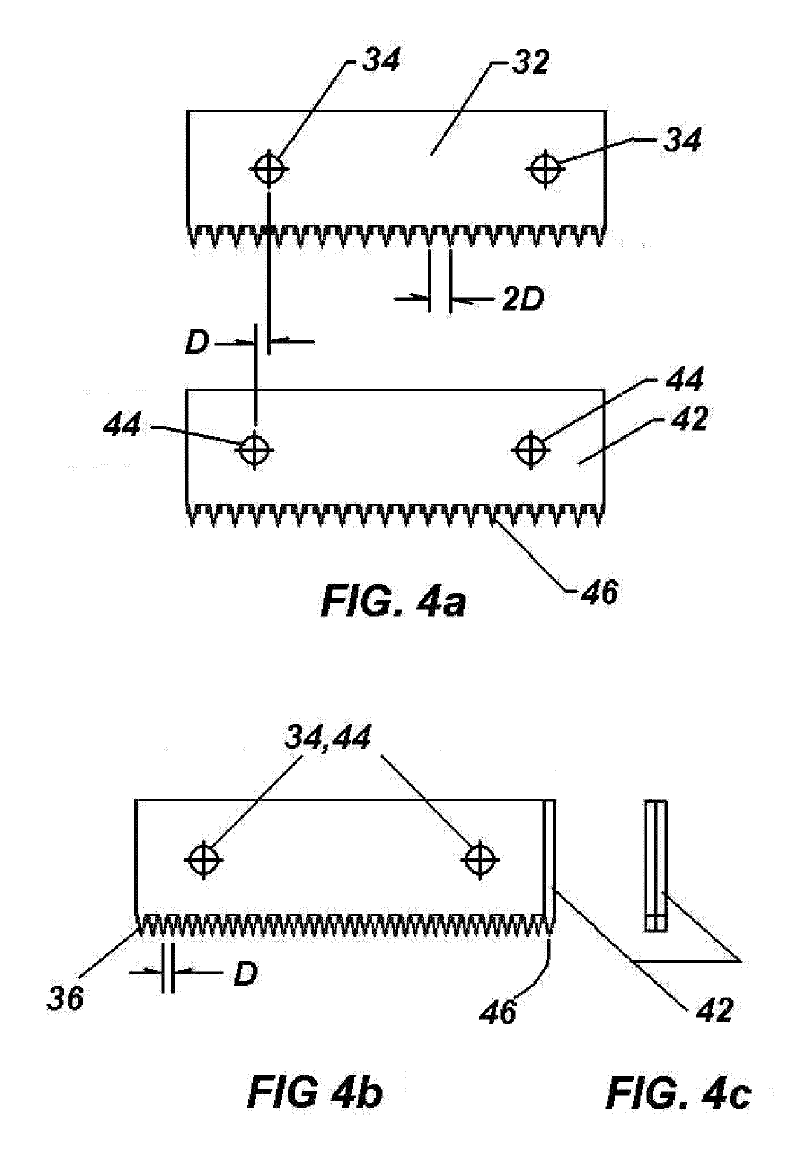

FIG. 4a shows a top plan view of the two plates 32, 42 and their offset relationship according to an embodiment disclosed in the present application. The teeth 36, 46 on each plate 32, 42 can be spaced equally apart with a pitch distance of 2D, which is two times the width of each tooth. However, alignment holes 34 of the plate 32 are longitudinally offset by a distance D with respect to alignment holes 44 of the plate 42. Distance D is half of the pitch distance 2D. Hence, when the two plates 32, 42 are superimposed together with alignment holes 34, 44 being aligned, the two rows of teeth 36, 46 can be longitudinally offset by a distance D.

As depicted in FIG. 4b, the two offset rows of teeth 36, 46 of the two superimposed and offset plates 32, 42 together can form a plurality of continuous serrated teeth 36, 46 with a pitch distance D, which is equal to the width of each tooth. FIG. 4c shows a side view of the two superimposed plates 32, 42 of FIG. 4b.

The teeth 36, 46 may have substantially the same width, height and shape. According to the illustrated embodiment, the teeth 36, 46 may be generally triangular in shape having a sharp or blunt end. In the illustrated embodiment, the teeth are generally isosceles triangular in shape.

Although it has been shown that the teeth 36, 46 on the two plates 32, 42 have the same width, height and shape, it is appreciated that the teeth 36, 46 on the two plate 32, 42 may have different widths, heights and shapes. For example, the teeth 36, 46 on the two plates 32, 42 may have the same width but different heights and shapes.

It has been shown and described that the teeth 36, 46 on the two plates 32, 42 are spaced equally apart with a pitch distance double the width of each tooth. However, it is understood by one skilled in the art that the teeth 36, 46 on the two plates 32, 42 may by in any other possible arrangements and may have different pitch distances. For example, the teeth 36, 46 on the two plates 32, 42 may be spaced equally apart with a pitch distance larger than the width of each tooth.

Furthermore, although it has been shown and described that the de-shedding tool 10 has two superimposed and offset plates 32, 42, it is understood by one skilled in the art that the de-shedding tool 10 may have three or more superimposed and offset plates.

Although it has been shown and described that the teeth 36, 46 on the plates 32, 42 are equally spaced apart, it is contemplated that the teeth 36, 46 can be spaced apart at different distances.

The de-shedding tool 10 may further include at least one more plate having at least one more row of equally spaced apart teeth formed along a longitudinal edge thereof. The two plates 32, 42 and the at least one more plate can be superimposed on each other and longitudinally offset such that the offset rows of equally spaced apart teeth can form a plurality of continuous serrated teeth. The teeth on each row of equally spaced apart teeth may be spaced equally apart at a distance at least double the width of each tooth.

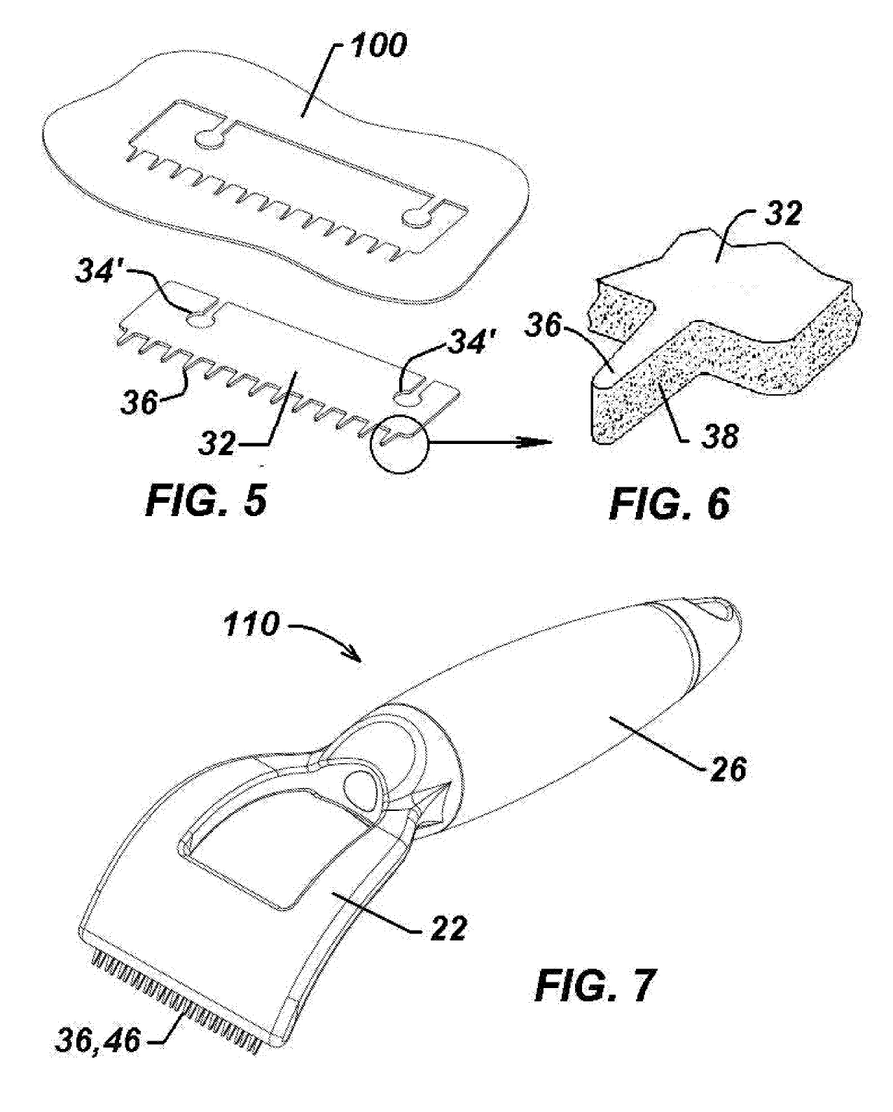

The two plates 32, 42 may be made of metal or any other suitable material. FIG. 5 shows a thin metal plate 32 being stamped out from a thin raw metal plate 100. During stamping, metal fractures and rough fracture surfaces 38 are formed along the sheared areas. The thinner the raw metal plate 100, the faster the stamping speed is used. When the stamping speed increases, heavier brittle fracture occurs and increases the roughness of the facture surfaces 38.

When a thick raw metal plate is used, the stamping speed slows down, and shearing on the surfaces 38 becomes ductile and ends up with less roughness. Thus, rough fracture surfaces 38 usually occur when stamping a thin metal plate having a thickness below 1.0 mm.

The fracture surfaces 38 so formed have a roughness sufficient to engage and pull away loose hair when the teeth 36, 46 slide through the hair of a pet. The teeth 36, 46 on the two plates 32, 42 of the de-shedding tool 10 can reach and engage the undercoat of the pet. When the teeth 36, 46 slide through the hair of the pet, it can de-shed the pet fast and effectively without cutting or pulling any non-loose hair.

FIG. 6 is an enlarged view of a tooth 36 of the metal plate 32 depicting the rough fracture surfaces 38 formed along the teeth after a stamping process. The rough fracture surfaces 38 can be adapted to engage and pull away loose hair when the teeth slide through the hair of an animal.

The steps of manufacturing the de-shedding tool 10 from metal according to an embodiment of the present application will be described below. First of all, a raw metal plate 100 with a thickness of less than 1.0 mm may be used. The raw metal plate 100 may be fed into a conventional stamping machine. The machine can stamp through the raw metal plate 100 to produce a first stamped metal plate 32 having, along a longitudinal edge thereof, a first row of equally spaced apart teeth 36. The first row of equally spaced apart teeth 36 has rough fracture surfaces 38 formed along the stamped edges after stamping. Two alignment holes 34 may be formed simultaneously on the first metal plate 32 during the stamping process.

Similarly, a second stamped metal plate 42 can be produced. The second metal plate 42 may have, along a longitudinal edge thereof, a second row of equally spaced apart teeth 46. The second row of equally spaced apart teeth 46 has rough fracture surfaces 38 formed along the stamped edges. Two alignment holes 44 may be formed simultaneously on the second plate 42 during the stamping process.

The first and second stamped metal plates 32, 42 can be superimposed on each other. The alignment holes 34 of the first metal plate 32 can be aligned with the alignment holes 44 of the second metal plate 42. In this aligned position, the row of teeth 36 on the first metal plate 32 can be longitudinally offset from the row of teeth 46 of the second metal plate 42 and together form a plurality of continuous serrated teeth 36, 46.

The two superimposed and offset metal plates 32, 42 can be mounted within the upper and lower housing portions 12a, 12b with the two rows of teeth 36, 46 exposed outwardly therefrom. Two screws 14 may be inserted through the alignment holes 34, 44 of the metal plates 32, 42 and fastening holes 24, 54 of the upper and lower housing portions 12a, 12b. Two nuts 64 may be threadably coupled to the two screws 14 for tightly fastening the two metal plates 32, 42 and the upper and lower housing portions 12a, 12b together.

It is contemplated that the two plates 32, 42 may be made of plastic by a cutting machine or by a molding machine.

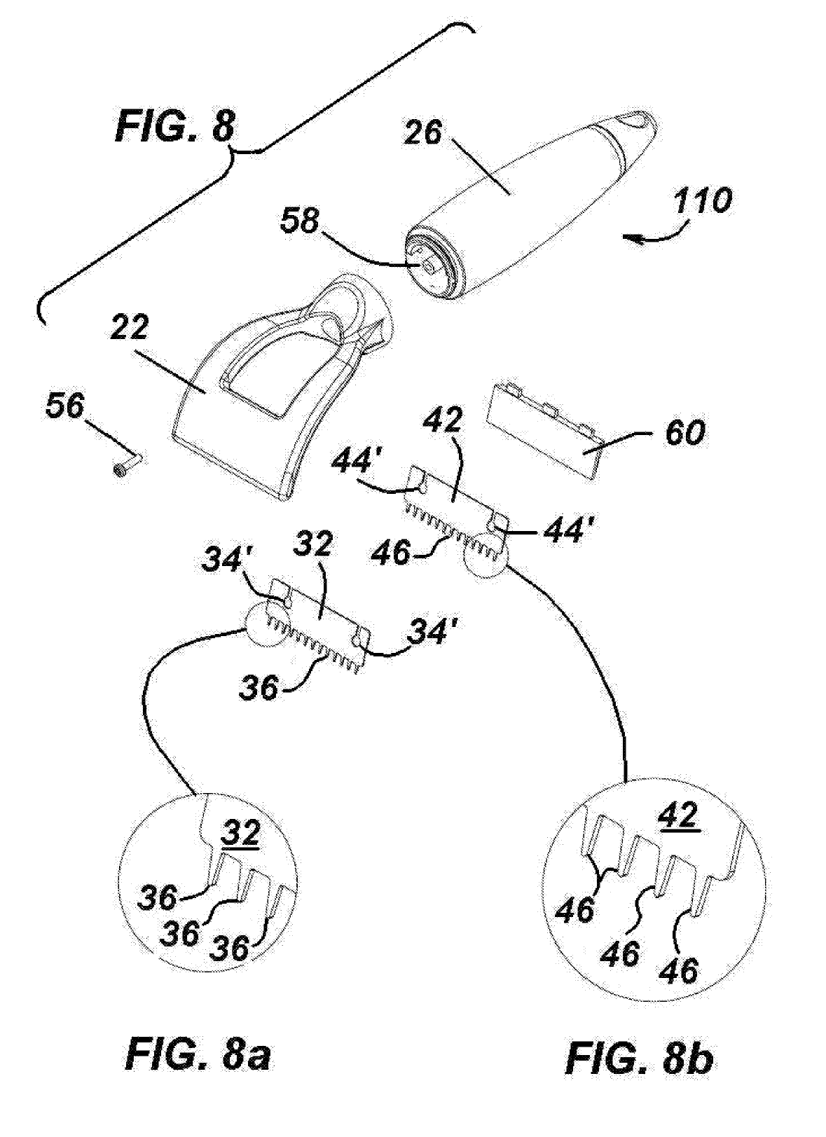

FIGS. 7-9 show the perspective and exploded views of a de-shedding tool 110 according to a second embodiment disclosed in the present application.

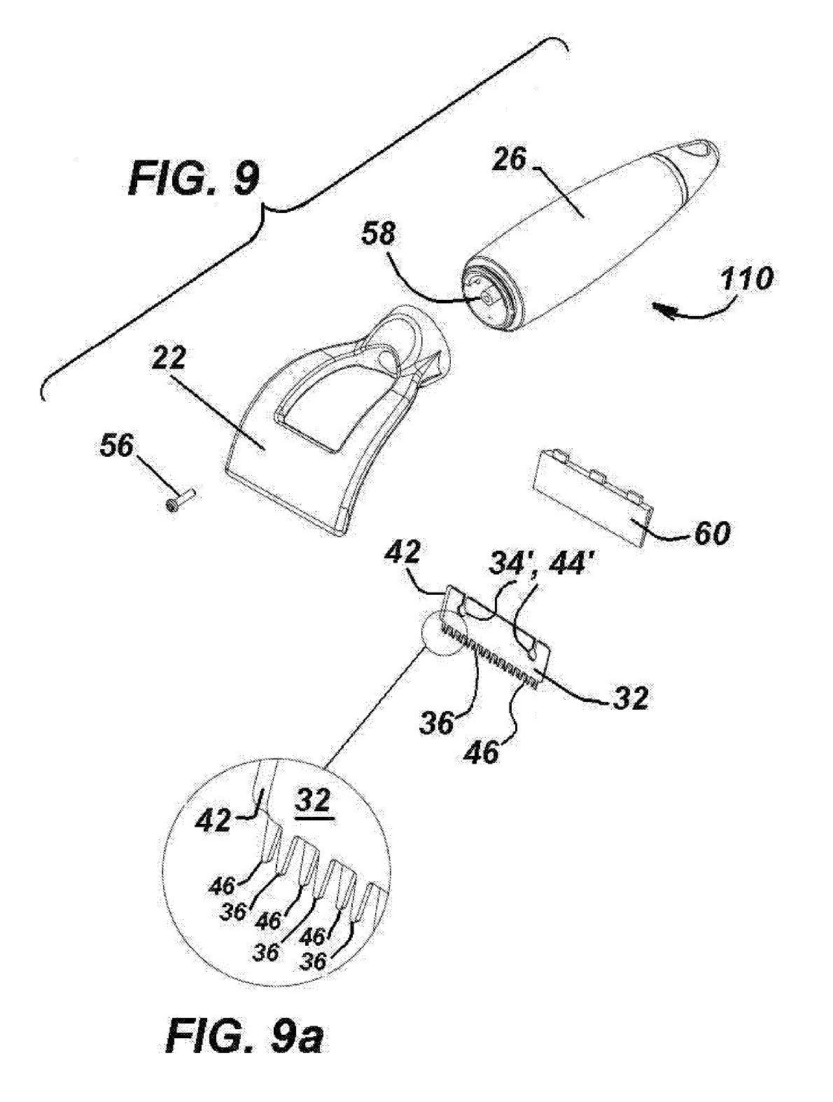

Similar to the first embodiment, the de-shedding tool 110 may include two thin plates 32, 42. Two rows of equally spaced apart teeth 36, 46 may be formed along the longitudinal edges of the two plates 32, 42 respectively. As shown in FIGS. 9 and 9a, the two plates 32, 42 may be superimposed on each other and longitudinally offset such that the two offset rows of teeth 36, 46 together form a plurality of continuous serrated teeth 36, 46.

The two plates 32, 42 are substantially the same as those in the first embodiment, except that alignment holes 34′, 44′ have slots by means of which the two plates 32, 42 can be guided into and held in position by a clip 60. The clip 60 may be mounted in the front portion of the housing 22 with the teeth 36, 46 exposed outwardly therefrom. A screw 56 may be threadably coupled to an internally threaded collar 58 integrally formed on a handle 26 for connecting the housing 22 thereto. The handle 26 can be in the form of an ergonomically designed handle for maximum comfort. The housing 22 can be disposed at an angle with respect to the handle 26 to make de-shedding easy and effective.

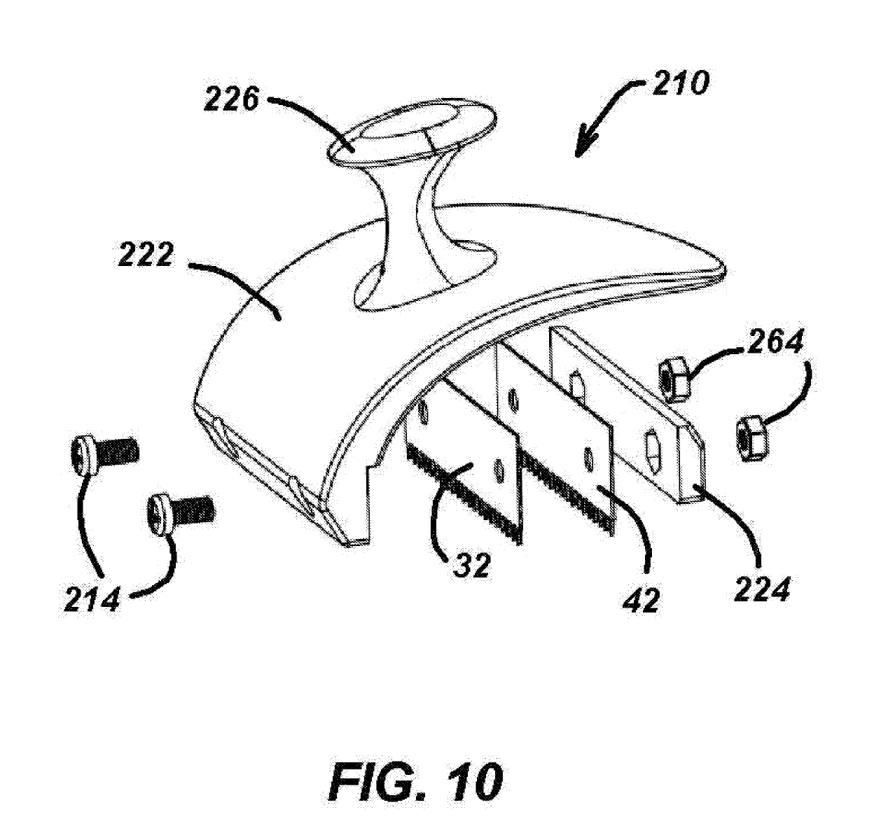

FIG. 10 shows a perspective view of a de-shedding tool 210 according to a third embodiment disclosed in the present application.

Similar to the first embodiment, the de-shedding tool 210 may include two thin plates 32, 42. Two rows of equally spaced apart teeth 36, 46 may be formed along the longitudinal edges of the two plates 32, 42 respectively. The two plates 32, 42 may be superimposed on each other and longitudinally offset such that the two offset rows of teeth 36, 46 together form a plurality of continuous serrated teeth 36, 46.

The de-shedding tool 210 may have an arcuate housing 222. The plates 32, 42 can be fastened between a front end portion of the housing 222 and a back plate 224 by a plurality of screws and nuts 214, 264.

A hand knob-shaped handle 226 may be provided on an upper surface of the housing 222. A user can hold the handle 226 and de-shed a pet without much twisting of the wrist of the user. Since the de-shedding tool 210 carries two thin and light plates 32, 42, it makes de-shedding of pet easy and effortless.

While the de-shedding tool disclosed in the present application has been shown and described with particular references to a number of preferred embodiments thereof, it should be noted that various other changes or modifications may be made without departing from the scope of the appending claims.

What is claimed is:

1. A de-shedding tool comprising:
first and second plates; and
first and second rows of spaced apart teeth formed along first and second longitudinal edges of the first and second plates respectively;
wherein the first and second plates are superimposed on each other and longitudinally offset such that the offset first and second rows of spaced apart teeth together form a plurality of continuous serrated teeth; and
wherein the teeth have surfaces with a roughness sufficient to engage and pull away loose hair when the teeth slide through the hair of an animal.

2. The de-shedding tool as claimed in claim 1, wherein the teeth on each row of spaced apart teeth are equally spaced apart.

3. The de-shedding tool as claimed in claim 2, wherein the teeth on each row of equally spaced apart teeth have a pitch distance larger than the width of each tooth.

4. The de-shedding tool as claimed in claim 2, wherein the teeth on each row of equally spaced apart teeth have a pitch distance double the width of each tooth, and the formed continuous serrated teeth have a pitch distance equal to the width of each tooth.

5. The de-shedding tool as claimed in claim 1, wherein the first and second plates are formed with alignment holes for aligning the first and second plates in a predetermined offset position.

6. The de-shedding tool as claimed in claim 1, wherein the teeth have substantially the same width, height and shape.

7. The de-shedding tool as claimed in claim 1, wherein the teeth are generally isosceles triangular in shape.

8. The de-shedding tool as claimed in claim 1, further comprising a housing for holding the first and second plates therein with the teeth exposed outwardly therefrom.

9. The de-shedding tool as claimed in claim 1, further comprising a handle integrally formed with the housing, wherein the first and second plates are oriented transversely and at an angle with respect to the handle.

10. The de-shedding tool as claimed in claim 1, further comprising a handle integrally formed with the housing, wherein the housing is generally arcuate in shape, and the handle is formed on an upper surface of the housing.

11. The de-shedding tool as claimed in claim 12, wherein the handle is generally in the form of a hand knob.

12. The de-shedding tool as claimed in claim 1, wherein the first and second plates are made of metal.

13. The de-shedding tool as claimed in claim 1, further comprising at least one more plate having at least one more row of spaced apart teeth formed along a longitudinal edge thereof; the first, second and at least one more plates being superimposed on each other and offset longitudinally such that the offset first, second and at least one more rows of teeth together form a plurality of continuous serrated teeth.

14. The de-shedding tool as claimed in claim 16, wherein the teeth on each row of teeth are spaced equally apart at a distance at least double the width of each tooth.

15. A method of manufacturing a de-shedding tool comprising the steps of:
producing a first plate having, along a longitudinal edge thereof, a first row of spaced apart teeth having surfaces with a roughness sufficient to engage and pull away loose hair when the teeth slide through the hair of an animal;
producing a second plate having, along a longitudinal edge thereof, a second row of spaced apart teeth having surfaces with a roughness sufficient to engage and pull away loose hair when the teeth slide through the hair of an animal; and
arranging the first and second plates in a superimposed and longitudinally offset position such that the offset first and second rows of spaced apart teeth together form a plurality of continuous serrated teeth.

16. The method as claimed in claim 15, further comprising the steps of forming first and second sets of longitudinally offset alignment holes in the first and second plate respectively.

17. The method as claimed in claim 15, further comprising the step of fastening the first and second plates in a housing with the teeth exposed outwardly therefrom.

18. The method as claimed in claim 17, further comprising the step of forming a handle with the housing.

19. The method as claimed in claim 15, wherein the plate-producing steps comprise producing the first and second plates from metal by stamping through a raw metal plate by a metal stamping machine.

20. The method as claimed in claim 15, wherein the plate-producing steps comprise producing the first and second plates from plastic by a cutting machine or a molding machine.
